(19) United States
(12) Patent Application Publication
(10) Pub. No.: US 2002/0012043 A1
(43) Pub. Date: Jan. 31, 2002

(54) Stereoscopic camera fitted with means to facilitate the adjustment of its opto-mechanical parameters

(76) Inventors: Jean-Claude Guerin, Saint-Pierre de Plesguen (FR); Pascal Malnoe, Rennes (FR)

Correspondence Address: THOMSON multimedia Licensing Inc., Patent Operations, P.O. Box 5312, Two Independence Way, Princeton, NJ, 08543-5312, US

(21) Appl. No.: 09/904,165

(22) Filed: Jul. 12, 2001

(30) Foreign Application Priority Data
Jul. 17, 2000 (FR) 0009305

(51) Int. Cl. H04N 13/02

(52) U.S. Cl. 348/47; 348/51

(57) ABSTRACT

The invention relates to a stereoscopic camera comprising means to facilitate the adjustment of its optomechanical parameters by an operator. To this end, it comprises storage means (16, 17) in order to store at least one stereoscopic image and a selection means (18) in order to selectively supply to the display means of the camera either the stored stereoscopic image, or the current stereoscopic image filmed by the 2D cameras (10, 11) of the stereoscopic camera.

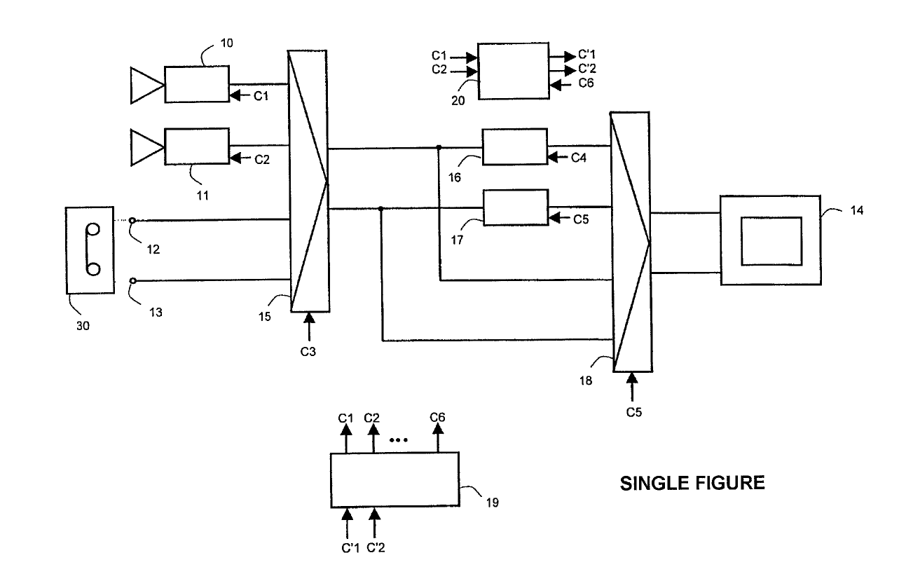

### BACKGROUND OF THE INVENTION

1. Field of the Invention

The present invention relates to a stereoscopic camera comprising means to facilitate the adjustment of its optomechanical parameters by an operator.

2. Description of the Prior Art

A stereoscopic camera simultaneously films two views of the same scene, a left view and a right view, so as to obtain relief images of the scene. To this end, it generally comprises two cameras, called 2D cameras, each delivering images in two dimensions corresponding respectively to a left view and a right view of the scene filmed. The adjustment of a stereoscopic camera consists in adjusting the optomechanical parameters of each of the 2D cameras and the parameters fixing the position of the 2D cameras one with respect to the other. This consists, for example, in adjusting the distance separating the two 2D cameras, the angle between the axes of the two 2D cameras, (commonly called the convergence angle), the focal length and the focus of the two 2D cameras.

The parameters are adjusted one after the other. Adjustment of a parameter consists in altering the value of the parameter in question until obtaining the best result. The adjustment is carried out roughly by the operator depending on his needs. Since the adjustment of each parameter affects the other parameters, the adjustment operation is often very lengthy. In addition, it is often very difficult to go backwards, when, after modifying several parameters, the operator considers that the earlier adjustments would be more suitable.

### SUMMARY OF THE INVENTION

The aim of the invention is to facilitate the adjustment of the optomechanical parameters of a stereoscopic camera.

To this end, the invention is a stereoscopic camera comprising first and second cameras intended to generate first and second sequences of images, respectively, each image of the said first sequence being associated with an image of the said second sequence, means to display a sequence of stereoscopic images from the said first and second sequences of images, first storage means in order to store respectively at least one image of the said first sequence of images and the associated image of the said second sequence of images, and first selection means placed upstream of the display means in order to selectively supply to the said display means either the said at least one stored image of the said first sequence of images and the associated stored image of the said second sequence of images, or the said first and second sequences of images coming from the said first and second cameras.

With this stereoscopic camera, it is then possible to store at least one stereoscopic image and to be able to display either the current stereoscopic image or the stored stereoscopic image. The aim of this form of embodiment is to facilitate comparison between the two images. In this way, before each operation of adjusting the parameters of the stereoscopic camera, a stereoscopic image is stored in the first and second storage means. Then, after altering at least one of the adjustment parameters, the adjustment thus obtained can be evaluated by comparing the current stereoscopic image with the stored stereoscopic image.

According to a variant, the stereoscopic camera also makes it possible to assess the connection between a current stereoscopic image and a stored stereoscopic image corresponding, for example, to a previous scene. In order to do this, the stereoscopic camera may also comprise first and second inputs in order to receive respectively third and fourth sequences of images coming from a piece of equipment external to the said stereoscopic camera, and second selection means in order to selectively supply to the said first storage means either the said first and second sequences of images coming from the said first and second cameras, or the said third and fourth sequences of images coming from the said external piece of equipment.

In order to facilitate the return to previous adjustments, it is possible to store values representative of the adjustment parameters of the first and second cameras. To this end, the stereoscopic camera may comprise a second storage means.

### BRIEF DESCRIPTION OF THE SOLE FIGURE

The characteristics of the invention mentioned above will appear clearer on reading the following description, made in relation to the single FIGURE which represents a form of embodiment of a stereoscopic camera according to the invention.

### DETAILED DESCRIPTION OF THE INVENTION

In the single FIGURE, a stereoscopic camera comprising two 2D cameras, referenced 10 and 11, is considered. They generate respectively first and second digital image sequences in two dimensions. The camera 10 films, for example, a left view of the scene to be filmed and the camera 11, a right view. Two control signals, denoted C1 and C2, are provided in order to control these two cameras. The control signals are delivered by a control circuit referenced 19. The stereoscopic camera also comprises two inputs, referenced 12 and 13, in order to receive respectively the third and fourth sequences of images delivered by an external piece of equipment 30, for example a video recorder or a hard disk. The images of the said third and fourth sequences relate, for example, to a scene filmed previously by the cameras 10 and 11, respectively. A selection means, referenced 15, is used in order to select either the first and second sequences of images, or the third and fourth sequences of images. This selection means is controlled by a control signal denoted C3 supplied by the control circuit 19. Normally, the two sequences selected are then transmitted to a stereoscopic display means, referenced 14, which then generates a sequence of stereoscopic images from these two sequences. The display means 14 is, for example, a pair of glasses with an LCD screen.

According to the preferred embodiment, two storage circuits, denoted 16 and 17, are provided in order for each one to store at least one digital image coming from the selection means 15. In the example illustrated, the storage circuit 16 is provided in order to store a digital image of the sequence coming either from the camera 10, or from the input 12 and the storage circuit 17 is itself placed in order to store either an image of the sequence coming from the camera 11, or from the input 13. The memory space needed to store a stereoscopic digital image is about 1.6 Mb for a single definition standard (PAL standard, for example). A control signal C4 is provided in order to simultaneously control the storage circuits 16 and 17. Finally, a second selection means 18 is provided in order to select the digital images to supply to the stereoscopic display means 14. This selection means is controlled by a control signal C5. This selection means outputs either the images coming from the storage circuits 16 and 17, or the images selected by the selection means 15.

With such a stereoscopic camera, it is thus possible to store images coming either from cameras 10 and 11, or from the external piece of equipment 30.

At the time of filming a scene, the operator can display the current scene filmed by the cameras 10 and 11, and compare it with a scene stored previously in the storage circuits 16 and 17. The selection means 18 is then used to switch between the two scenes. The operator can then compare the two scenes and act on the controls of the stereoscopic camera in order to adjust the parameters of the camera according to his needs. Note that, in order that the comparison of two images is conclusive, it is necessary that the images compared are of the same quality. It is therefore preferable that the images stored in the circuits 16 and 17 are not compressed.

Of course, the means of the invention can be used in a camera with multiple views comprising n 2D cameras. In this case, the camera then comprises n storage circuits.

Advantageously, the stereoscopic camera also comprises an additional storage circuit 20 in order to store values of control signals C1 and C2 of cameras 10 and 11, the stored signals C1 and C2 corresponding to a given adjustment of the stereoscopic camera. Thus, before altering the optomechanical parameters of the camera, the operator stores the control signals corresponding to a starting adjustment. He may then alter the value of these parameters in order to try to improve the adjustment. If he considers that the new adjustment is less beneficial than the starting adjustment, the operator can then recover the stored signals C′1 and C′2 which correspond to the starting adjustment. Advantageously, the storage circuit 20 stores all the signals sent to the cameras 10 and 11 which may correspond to the values of many parameters such as the distance between the cameras 10 and 11, the angle between the axes of the cameras 10 and 11, the focal length, the focus and the gain or the aperture of the iris of cameras 10 and 11.

What is claimed is:

1. A stereoscopic camera comprising
first and second cameras (10, 11) intended to generate first and second sequences of images, respectively, each image of the said first sequence being associated with an image of the said second sequence, and
means (14) to display a sequence of stereoscopic images from the said first and second sequences of images,
first storage means (16, 17) in order to store respectively at least one image of the said first sequence of images and the associated image of the said second sequence of images, and
a first selection means (18) placed upstream of the display means and intended to selectively supply to the said display means (14) either the said at least one stored image of the said first sequence of images and the associated stored image of the said second sequence of images, or the said first and second sequences of images coming from the said first and second cameras (10, 11).

2. A stereoscopic camera according to claim 1, wherein said camera further comprises:
first and second inputs (12, 13) in order to receive respectively third and fourth sequences of images coming from a piece of equipment external to the said stereoscopic camera, each image of the said third sequence being associated with an image of the said fourth sequence, and
a second selection means (15) in order to selectively supply to the said first storage means (16, 17) either the said first and second sequences of images coming from the said first and second cameras (10, 11), or the said third and fourth sequences of images coming from the said external piece of equipment.

3. The stereoscopic camera according to claim 1, wherein the said first storage means (16, 17) comprise two storage circuits in order for each one to store at least one image.

4. The stereoscopic camera according to claim 1, wherein said camera comprises a second storage means (19) intended to store values representative of adjustment parameters of the said first and second cameras (10, 11), especially the values representative of the angle and the distance between the said first and second cameras, their focal lengths and their respective focuses.

5. The stereoscopic camera according to claim 2, wherein the external piece of equipment is a video recorder.

6. The stereoscopic camera according to claim 2, wherein the external piece of equipment is a hard disk of a recording device.
